(19) United States
(12) Patent Application Publication
(10) Pub. No.: US 2010/0241574 A1
(43) Pub. Date: Sep. 23, 2010

(54) SYSTEM FOR ANONYMOUSLY NEGOTIATING THE PRICE OF A PARTICULAR PRODUCT TO BE PURCHASED AT A LATER TIME FROM A PARTICULAR VENDOR

(76) Inventor: JUAN SALAZAR, Coral Springs, FL (US)

Correspondence Address: MARK TERRY, ESQ., 801 BRICKELL AVE., SUITE 900, Miami, FL, 33131, US

(21) Appl. No.: 12/406,822

(22) Filed: Mar. 18, 2009

(51) Int. Cl. G06Q 30/00

(52) U.S. Cl. 705/80

(57) ABSTRACT

A system for anonymously negotiating the price of a particular product to be purchased at a later time from a particular vendor. The system uses at least one consumer terminal, an intermediary entity, and at least one vendor terminal to (1) identify a particular item for sale at a Brick and Mortar Retailer, whereby the particular item has a stated purchase price that was decided by the Brick and Mortar Retailer, (2) anonymously place an offer for the particular item at a desired price, whereby the desired price is less than the stated purchase price, (3) purchase the item at the Brick and. Mortar Retailer at the stated price, and (4) receive a credit equal to the difference between the stated price and the desired price upon submitting proof that the transaction at the Brick and Mortar Retailer has been completed.

### BACKGROUND

The present invention relates to systems used in commerce, specifically systems for anonymously negotiating the price of a particular product to be purchased at a later time from a particular vendor.

There are currently many models and systems used in conducting commerce, some models and systems are more efficient than others, nonetheless the essence of trade, i.e. the sale and purchase of goods and services, remains the same.

Today, thanks greatly to the breakthroughs in information technology and communications, e-commerce systems have proven to be very well received systems of conducting trade. While a significant percentage of e-commerce is used for purchasing virtual items, such as access to premium content of a website, the majority of trade continues to revolve around the purchase of physical objects at traditional “Brick and Mortar Retailers”. The term “Brick and Mortar Retailer” refers to the traditional storefront with a physical location as opposed to a “Virtual Retailer” that has no physical location and connects commerce over the Internet using e-commerce systems.

Despite the recent success of virtual stores and other online e-commerce vehicles, the traditional Brick and Mortar Retailer continues to play an important role in the trade industry and has been forced to evolve and adapt to the demands of commerce in the digital era.

Since the early days of trading in agrarian societies, face to face negotiations have played an important role in conducting commerce. As commerce evolved from agrarian markets to brick and mortar storefronts, the negotiation process has slowly been eroded and placed from the forefront of commerce to essentially an afterthought. In today's modern society, much of the consuming population would not dare to negotiate the stated price of a product for sale at a Brick and Mortar Retailer. The reasons for such a change of feelings towards the negotiation process can be linked to both psychological and technological factors.

Psychologically speaking, consumers often fear the stigma attached to being labeled a “bargain hunter” within the circles of the retail industry or simply lack the confidence to negotiate face to face with retailers for fear that their offer will not be accepted. It is a common conception, however misplaced it may be, that the retailer holds the power of negotiation and the consumer must simply comply with the stated price of a particular product.

Technologically speaking, the point of sale systems used by most retailers are simply not designed to accommodate the negotiation process. These systems are often pre-programmed with specific programs that cannot be altered to facilitate or accommodate the negotiation process. In other words, most retailers are not equipped with a retail mechanism or device that would allow a consumer to make an offer other than the stated price on the particular product.

It is simple economics to understand that retailers endure financial losses if they are unable to sell their inventory. When retailers are unable to sell their inventory, it is common practice for retailers advertise the “un-sellable inventory” at greatly discounted prices. In an effort to sell inventory that is not selling well, it is possible that a retailer might offer a discounted price for a particular good that is less than the price that a consumer would have purchased the good, had the consumer been able make their own offer. It is simple psychology to understand that a consumer is more likely to purchase a product if the consumer can decide, or at least have an active role in determining the purchase price of a product.

The traditional methods of engaging in commerce with Brick and Mortar Retailers make it very difficult for consumers to have an active role in determining the purchase price of a product due in part, because among other reasons, (1) the customer has little or virtually no bargaining power compared to the bargaining power of the retailer, (2) the point of sale systems used by the retail industry are preprogrammed with set prices for particular products, and (3) the current systems do not provide a means in which a customer may anonymously, quickly and easily make a real time offer, while in the Brick and Mortar Retailer's storefront for the purchase of a particular product.

Clearly, the market is aware of these issues; however, an adequate manner to address them has yet to be implemented.

In order to address the aforementioned problems, the inventor has created a system for anonymously negotiating the price of a particular product to be purchased at a later time from a particular vendor. The system uses at least one consumer terminal, an intermediary entity, and at least one vendor terminal.

Using the present invention, a customer can (1) identify a particular item for sale at a Brick and Mortar Retailer, whereby the particular item has a stated purchase price that was decided by the Brick and Mortar Retailer, (2) anonymously place an offer for the particular item at a desired price, whereby the desired price is less than the stated purchase price, (3) purchase the item at the Brick and Mortar Retailer at the stated price, and (4) receive a credit equal to the difference between the stated price and the desired price upon submitting proof that the transaction at the Brick and Mortar Retailer has been completed.

The system of the present invention allows for consumers to have an active role in the negotiating process, while maintaining their anonymity. As such, the consumer does not have to confront the psychological issues inherent in negotiations that are conducted face to face. Moreover, as the consumer apparently “purchases” the product at the stated price at the point of sale location of the Brick and Mortar Retailer, even the sales clerk is not aware that the consumer has negotiated the purchase price of the product in question. At the same time, the Brick and Mortar Retailer is able to sell particular items at discounted purchase prices without advertising a discount to the public.

An objective of the present invention is to provide a system that allows a consumer to anonymously negotiate the price for a particular product offered at a Brick and Mortar Retailer.

Another objective of the present invention is to provide a system that allows a consumer to have an active role in determining the purchase price of a particular product offered for sale at a Brick and Mortar Retailer.

Another objective of the present invention is to provide a system that allows a Brick and Mortar Retailer to sell inventory that is not otherwise selling well.

Another objective of the present invention is to provide a system that allows a consumer to negotiate without being bound to an offer.

Another objective of the present invention is to provide a negotiation system that is not intrusive to Brick and Mortar Retailer's information systems.

Yet, a further objective of the present invention is to provide a system that allows a Brick and Mortar Retailer to sell a product at a lower price without advertising the lower price to the public.

Information relevant to attempts to address these problems can be found in U.S. Pat. No. 7,107,228, U.S. Pat. No. 5,794,207, U.S. Pat. No. 7,200,566, and U.S. Pat. No. 7,107,228. However, each one of these reference suffers from one or more of the following disadvantages. The above references do not discloses systems that maintain the anonymity of the purchaser throughout the negotiation and purchase process nor do they provide a method of crediting the consumer after the consumer purchases the product at the stated price of the Brick and Mortar Retailer.

For the foregoing reasons there exists a need for system for anonymously negotiating the price of a particular product to be purchased at a later time from a particular vendor whereby the system allows for a consumer to (1) identify a particular item for sale at a Brick and Mortar Retailer, whereby the particular item has a stated purchase price that was decided by the Brick and Mortar Retailer, (2) anonymously place an offer for the particular item at a desired price, whereby the desired price is less than the stated purchase price, (3) purchase the item at the Brick and Mortar Retailer at the stated price, and (4) receive a credit equal to the difference between the stated price and the desired price upon submitting proof that the transaction at the Brick and Mortar Retailer has been completed.

### SUMMARY

A system for anonymously negotiating the price of a particular product to be purchased at a later time from a particular vendor. The system uses at least one consumer terminal, an intermediary entity, and at least one vendor terminal.

Using the present invention, a customer can (1) identify a particular item for sale at a Brick and Mortar Retailer, whereby the particular item has a stated purchase price that was decided by the Brick and Mortar Retailer, (2) anonymously place an offer for the particular item at a desired price, whereby the desired price is less than the stated purchase price, (3) purchase the item at the Brick and Mortar Retailer at the stated price, and (4) receive a credit equal to the difference between the stated price and the desired price upon submitting proof that the transaction at the Brick and Mortar Retailer has been completed.

The system of the present invention allows for consumers to have an active role in the negotiating process, while maintaining their anonymity. As such, the consumer does not have to confront the psychological issues inherent in negotiations that are conducted face to face. Moreover, as the consumer apparently “purchases” the product at the stated price at the point of sale location of the Brick and Mortar Retailer, even the sales clerk is not aware that the consumer has negotiated the purchase price of the product in question. At the same time, the Brick and Mortar Retailer is able to sell particular items at discounted purchase prices without advertising a discount to the public.

### DRAWINGS

These and other features, aspects, and advantages of the present invention will become better understood with regard to the following description, appended claims and drawings where:

FIG. 1 shows a diagram of the interaction between the consumer terminal, the intermediary, and the vendor terminal;

FIG. 2 shows a diagram of each of the interactions between data exchange managers; and

FIG. 3 shows a flowchart of the system when a transaction is completed.

### DESCRIPTION

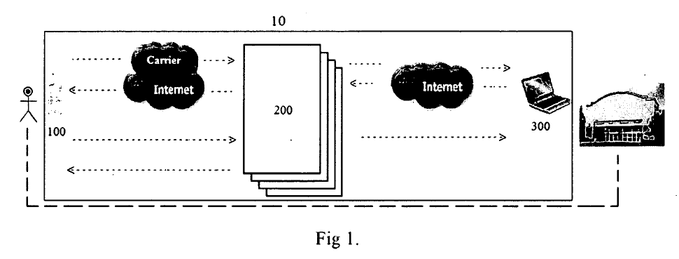

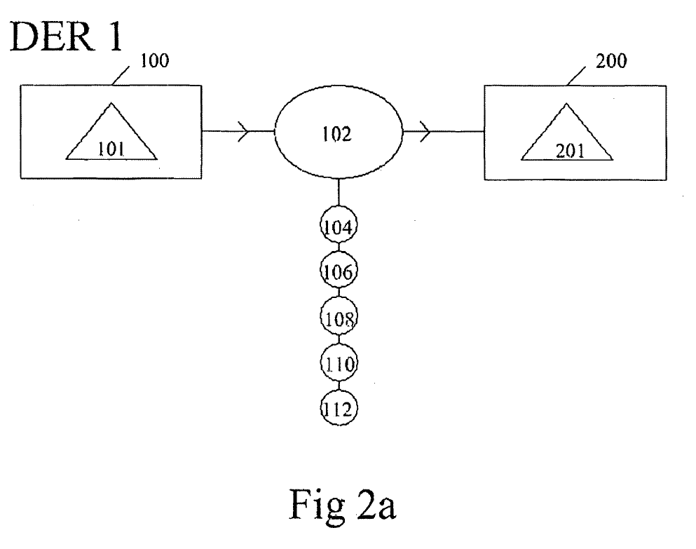

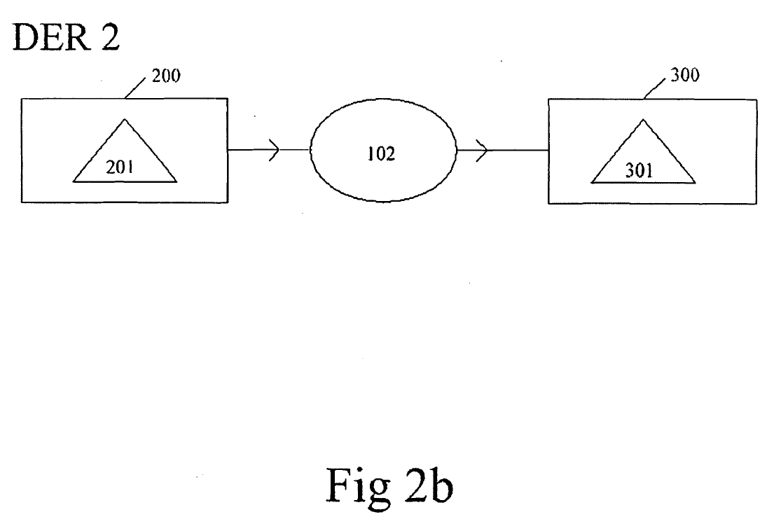

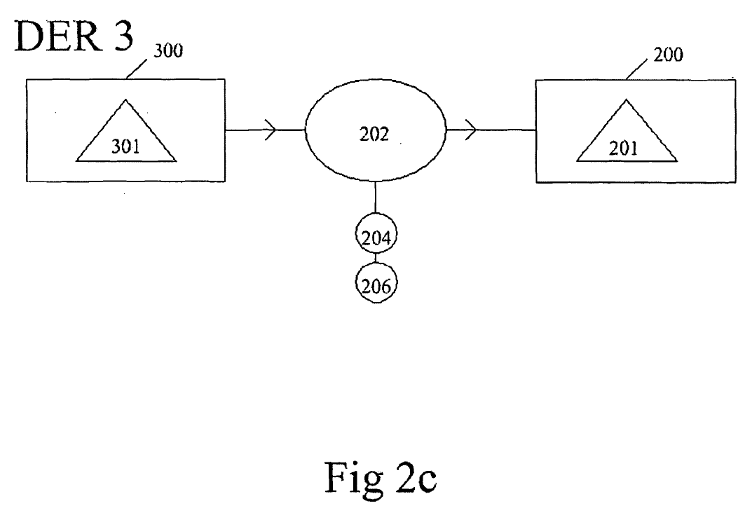

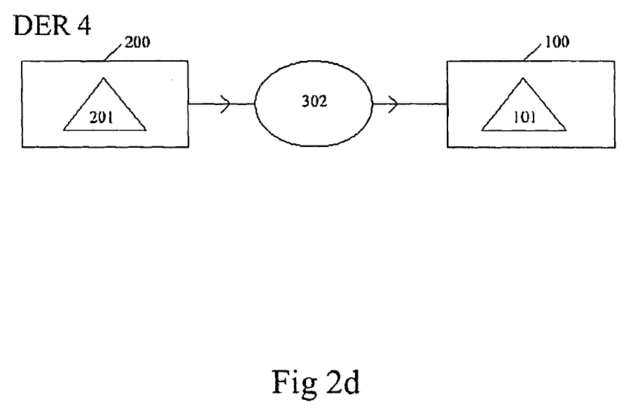

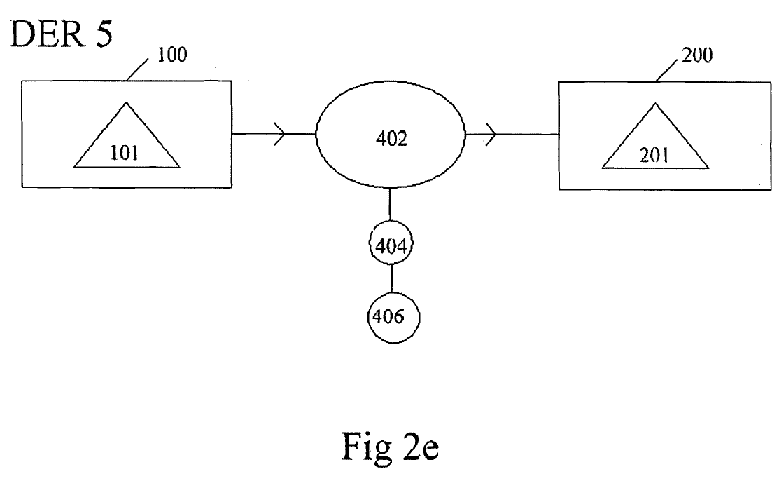

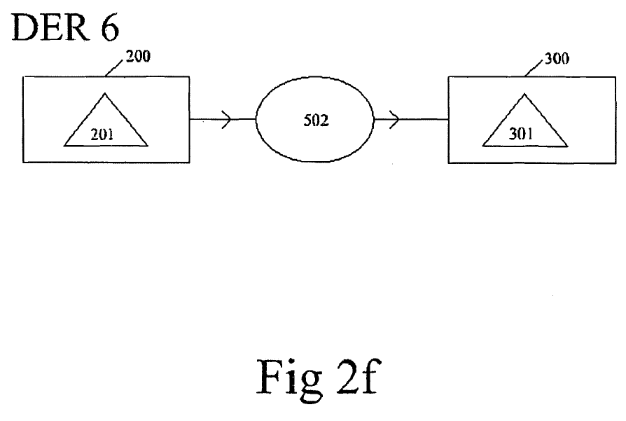

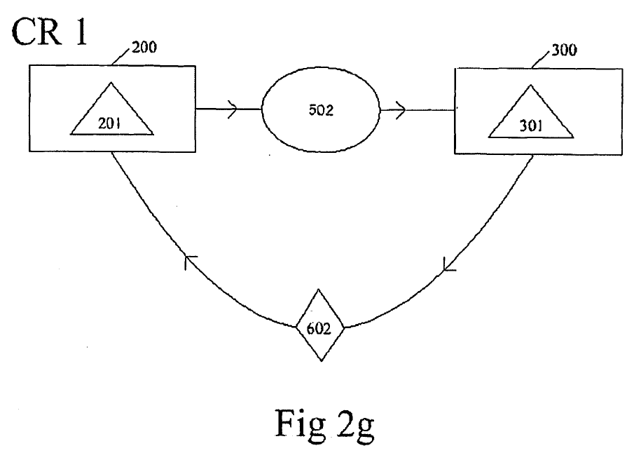

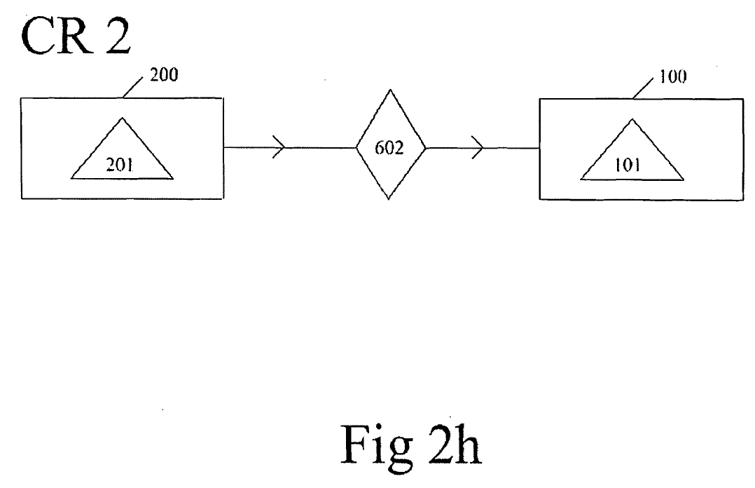

As shown in FIG. 1, system for anonymously negotiating the price of a particular product to be purchased at a later time from a particular vendor, the system 10 comprising at least one consumer terminal 100, an intermediary entity 200, and at least one vendor terminal 300.

Each consumer terminal 100 has a data exchange manager 101 for storing and transferring a predetermined set of data, the consumer terminal 100 exchanges information with an intermediary entity 200, the intermediary entity 200 has a data exchange manager 201 for storing and transferring a predetermined set of data, the intermediary entity 200 exchanges information with each consumer terminal 100 and at least one vendor terminal 300, each vendor terminal 300 has a data exchange manager 301 for storing and transferring a predetermined set of data and each vendor terminal 300 exchanges information with the intermediary entity 200.

It is envisioned that the consumer terminal 100, might be a mobile computing device that is known in the art or a mobile computing device that has similar characteristics or functions as a smart phone, a Personal Digital Assistant (PDA), a personal computer, or similar device known in the art.

It is envisioned that each consumer terminal 100, might have the capacity to store and process information as well as transmit and receive said information using network or wireless network technologies.

It is envisioned that the intermediary entity 200, might have the capacity to store and process information as well as transmit and receive said information using network or wireless network technologies.

In one embodiment it is envisioned that each vendor terminal 300 will be have the capacity to store and process information as well as transmit and receive said information using network or wireless network technologies.

In another embodiment, it is envisioned that each vendor terminal 300 might be in communication with the storefront of a traditional “Brick and Mortar” retailer and might have the capacity to store and process information as well as transmit and receive said information using network or wireless network technologies.

The intermediary entity 200 engages in a series of data exchange relationship DER1-6 and contractual relationships CR1-2.

The intermediary entity 200 has a first data exchange relationship DER1 with at least one consumer terminal 100, the first data exchange relationship DER1 having terms whereby the consumer terminal 100 delivers data 102 to the intermediary entity 200. The data 102 of the first data exchange relationship DER1 might comprise of identifying information 104 for a particular product, identifying information 108 of a particular vendor terminal 300 associated with the product, a desired price 110 for each product identified, and a time parameter 112 that determines the validity of the desired price 110. It is envisioned that the desired price 110 for each product is less than the stated price 106. The data 102 exchanged in the first data exchange relationship DER1 is stored and delivered using a data exchange manager 201. It is envisioned that the consumer terminal 100 might deliver the data 102 to the intermediary entity 200 in a variety of ways, including scanning photographing, or manually inputting information related to the particular product; also geo referencing via GPS, geo triangulation or manually inputting information related to the particular vendor.

By way of example, if a consumer located a television with a barcode of 4321 for sale at XYZ, Co., whose vendor code is ABCD, for $1000.00, and the consumer wanted to purchase the television from XYZ, Co. for $750.00, then the first data exchange DER1 for such a transaction might include the following: the 4321 barcode as identifying information of the particular product; $1000.00 as the stated price of the product; the ABCD vendor code as identifying information of a particular vendor associated with the particular product; $750.00 as the desired price for the product; and one (1) hour as the time parameter that determines the validity of the desired price of $750.00.

The identifying information for a particular product 104, might comprise of a barcode, an alphanumeric code or a photograph of the particular product in question. It is envisioned that the consumer terminal 100 might deliver the data 102 of the first data exchange relationship DER1 to the intermediary entity 200 via telephony technology, internet technology, network technology or information exchange technology known in the art.

The intermediary entity 200 has a second data exchange relationship DER2 with at least one vendor terminal 300, the second data exchange relationship DER2 having terms whereby the intermediary entity 200 delivers data 102 to a particular vendor terminal 300. The data 102 exchanged in the second data exchange relationship DER2 is essentially the same data 102 received from each consumer terminal 100 through the first data exchange DER1; however any information identifying the consumer terminal 100 is not delivered to the particular vendor terminal 300. The data 102 exchanged in the second data exchange relationship DER2 is stored and delivered using a data exchange manager 201.

Continuing the above example, in the second data exchange relationship the intermediary entity would deliver to the vendor terminal data comprising of the 4321 barcode; the corresponding stated price of $1000.00; the corresponding ABCD vendor code; the $750.00 desired price; and the 1 hour time parameter determining the validity of the $750.00 desired price.

The intermediary entity 200 further has a third data exchange relationship DER3 with at least one vendor terminal 300, the third data exchange relationship DER3 having terms whereby each vendor terminal 300 delivers data 202 to the intermediary entity 200. The data 202 exchanged in the third data exchange DER3 comprises of alphanumeric values 204 in response to the desired price 110 delivered by the consumer terminal 100 in the first data exchange relationship DER1. It is envisioned that the alphanumeric values 204 might correspond to an acceptance of the desired price 110, a rejection of the desired price 110, or a counteroffer in response to the desired price 110. It is envisioned that alphanumeric values 204 corresponding to an acceptance of the desired price 110 might be in the form of an electronic coupon that may be printed on a printer at a satellite location. It is also envisioned that the alphanumeric values 204 might have a time parameter 206 that determines the validity of the alphanumeric value 204 of the third data exchange DER3. The data 202 exchanged in the third data exchange relationship DER3 is stored and delivered using a data exchange manager 301.

Continuing the example, if the vendor terminal accepts the $750.00 desired, then the vendor terminal will deliver an alphanumeric value to the intermediary entity corresponding to an acceptance of the desired price of $750.00. If, on the other hand, the vendor terminal rejects the $750.00 desired price, then the vendor terminal will deliver an alphanumeric value to the intermediary entity corresponding to a rejection of the $750.00 desired price. In the event the vendor terminal rejects the $750.00 desired price, the transaction is terminated until an alternative desired price or counter offer is submitted.

The intermediary entity 200 further has a fourth data exchange relationship DER4 with each consumer terminal 100, the fourth data exchange relationship DER4 with each consumer terminal 100 having terms whereby the intermediary entity 200 delivers data 302 to each consumer terminal 100 according to the data 202 exchanged in the third data exchange DER3. The data 302 exchanged in the fourth data exchange relationship DER4 is stored and delivered using a data exchange manager 201.

Continuing the example, the alphanumeric value corresponding to an acceptance or rejection of the $750.00 desired price is delivered to the consumer terminal during the fourth data exchange relationship; however, the consumer is not bound to purchase the television. In the event the alphanumeric value corresponds to a rejection, the consumer will either (1) cease the transaction process or (2) return to the first data exchange and submit an alternative desired price for the television.

The intermediary entity 200 further has a fifth data exchange relationship DER5 with each consumer terminal 100, the fifth data exchange relationship DER5 with each consumer terminal 100 comprises terms whereby each consumer terminal 100 delivers data 402 to the intermediary entity 200 comprising of a confirmation 404 that the product identified 104 in the first data exchange DER1 was purchased from the vendor terminal 300 at the stated price 406. The data 402 exchanged in the fifth data exchange relationship DER5 is stored and delivered using a data exchange manager 101.

Continuing the example, assuming the $750.00 desired price is approved; the consumer may purchase the television from XYZ, Co. at the stated price of $1000.00 in order to continue the transaction process. Once the television is purchased at XYZ, Co. at the stated price of $1000.00, the consumer is given a confirmation stating that the television was purchased from XYZ, Co. at the stated price of $1000.00. It is envisioned that the confirmation might comprise alphanumeric values in the form of an invoice. The confirmation is delivered to the intermediary entity confirming that the television was purchased at the stated price of $1000.00.

The intermediary entity 200 further has a sixth data exchange relationship DER6 with each vendor terminal 300, the sixth data exchange relationship DER6 with each vendor terminal 300 comprising of terms whereby the intermediary entity 200 delivers data 502 to each vendor terminal 300 according to the data 402 exchanged in the fifth data exchange DER5. The data 502 exchanged in the sixth data exchange relationship DER6 is stored and delivered using a data exchange manager 201.

Continuing the example, the confirmation delivered to the intermediate entity, stating that the television was purchased at $1000.00 is delivered to the XYZ, Co's vendor terminal during the sixth data exchange relationship.

The intermediary entity 200 further has a first contractual relationship CR1 with each vendor terminal 300, the first contractual relationship CR1 having terms whereby upon the confirmation 404 that the product identified 104 in the first data exchange relationship DER1 has been purchased, the vendor terminal 300 delivers value 602 to the intermediary entity 200 equal to the difference between the stated price 406 identified in the fifth data exchange DER5 and the approved desired price of the product 204.

Continuing the example, once XYZ, Co's vendor terminal receives confirmation from the intermediate entity that the television was purchased from XYZ, Co. at the stated price of $1000.00, then XYZ, Co. then XYZ, Co is contractually bound to delivers a credit to the intermediate terminal in the amount of $250.00, equal to the difference between the stated purchase price of $1000.00 and the approved desired price of $750.00.

The intermediary entity 200 further has a second contractual relationship CR2 with each consumer terminal 100, the second contractual relationship CR2 having terms whereby upon the confirmation 404 that the consumer has purchased the product identified 104 in the first data exchange relationship DER1 and the intermediary entity 200 has received value 602 from the vendor terminal 300, the intermediary entity 200 will deliver value 602 to the consumer terminal 100 equal to the difference between the stated price 406 identified in the fifth data exchange relationship DER5 and the approved desired price of the product 204. It is envisioned that the delivery of the value 602 to the consumer terminal 100 might be in the form of an electronic funds transfer or similar electronic transfer of funds known in the art.

Continuing the example, once the intermediate entity receives the value from XYZ, Co. in the amount of $250.00, the intermediate entity is contractually bound to deliver the $250.00 value to the consumer terminal.

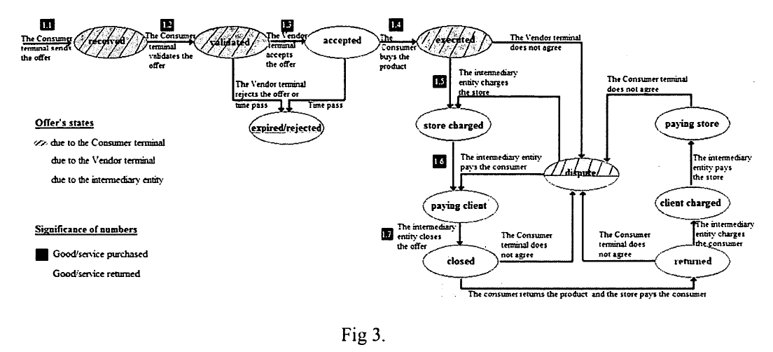

FIG. 3 illustrates in the form a of flowchart how a transaction using the system 10 might occur.

In operation, the system 10 allows for consumers to anonymously negotiate the price of particular item and then subsequently purchase the particular item at the negotiated price without having to negotiate face to face.

The system 10 of the present invention allows for consumers to have an active role in the negotiating process, while maintaining their anonymity. As such, the consumer does not have to confront the psychological issues inherent in negotiations that are conducted face to face. Moreover, as the consumer apparently “purchases” the product at the stated price at the point of sale location of the Brick and Mortar Retailer, even the sales clerk is not aware that the consumer has negotiated the purchase price of the product in question. At the same time, the Brick and Mortar Retailer is able to sell particular items at discounted purchase prices without advertising a discount to the public.

An advantage of the present invention is that it provides a system that allows a consumer to anonymously negotiate the price for a particular product offered at a Brick and Mortar Retailer.

Another advantage of the present invention is that it provides a system that allows a consumer to have an active role in determining the purchase price of a particular product offered for sale at a Brick and Mortar Retailer.

Another advantage of the present invention is that it provides a system that allows a Brick and Mortar Retailer to sell inventory this not otherwise selling well.

Another advantage of the present invention is that it provides a system that allows a consumer to negotiate without being bound to an offer. Another advantage of the present invention is that it provides a negotiation system that is not intrusive to Brick and Mortar Retailer's information systems. Yet, a further advantage of the present invention is that it provides a system that allows a Brick and Mortar Retailer to sell a product at a lower price without advertising the lower price to the public.

Although the present invention has been described in considerable detail with reference to certain preferred versions thereof, other versions are possible. Therefore, the spirit and the scope of the claims should not be limited to the description of the preferred versions contained herein.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method on a server for remotely negotiating a sale price for a product offered for sale at a stated price at a brick and mortar store, comprising:
receiving from a remote terminal an offer from a consumer to buy the product at an offer price less than the stated price;
determining that the offer price is acceptable;
transmitting an acceptance of the offer price to the remote terminal;
receiving data confirming that the product was purchased by the consumer at the stated price at the brick and mortar store; and
transferring to the consumer a credit equal to the difference between the stated price and the offer price.

22. The method of claim 21, wherein the step of receiving from a remote terminal an offer from a consumer further comprises:
receiving from a remote terminal an offer from a consumer to buy the product at an offer price less than the stated price, and a value indicating a time period during which the offer price is valid.

23. The method of claim 22, wherein the step of transmitting further comprises:
transmitting an acceptance of the offer price to the remote terminal before the time period has expired.

24. The method of claim 23, wherein the step of determining further comprises:
comparing the offer price to a predefined reserve price and determining that the offer price is acceptable of the offer price is equal to or greater than the reserve price.

25. The method of claim 24, wherein the step of receiving data further comprises:
receiving, from a second remote terminal at the brick and mortar store, data confirming that the product was purchased by the consumer at the stated price at the brick and mortar store, wherein the data pertains to a point of sale transaction corresponding to purchase of the product by the consumer.

26. The method of claim 25, wherein the step of receiving data further comprises:
receiving, from the remote terminal, data from the consumer confirming that the product was purchased by the consumer at the stated price at the brick and mortar store, wherein the data pertains to the point of sale transaction corresponding to purchase of the product by the consumer.

27. The method of claim 21, wherein the step of receiving data further comprises:
receiving data pertaining to a point of sale transaction corresponding to purchase of the product by the consumer at the stated price at the brick and mortar store; and
processing the data to determine its authenticity.

28. The method of claim 27, wherein the step of receiving data pertaining to a point of sale transaction further comprises:
receiving, from a second remote terminal at the brick and mortar store, data pertaining to the point of sale transaction corresponding to purchase of the product by the consumer at the stated price at the brick and mortar store.

29. The method of claim 27, wherein the step of receiving data pertaining to a point of sale transaction further comprises:
receiving, from the remote terminal, data pertaining to the point of sale transaction corresponding to purchase of the product by the consumer at the stated price at the brick and mortar store.

30. The method of claim 25, wherein the step of transferring to the consumer further comprises:
initiating an electronic transfer of funds to an account of the consumer of an amount of money equal to a difference between the stated price and the offer price.

31. A method on a server for remotely negotiating a sale price for a product offered for sale at a stated price at a brick and mortar store, comprising:
receiving from a remote terminal an offer from a consumer to buy the product at an offer price less than the stated price;
transmitting the offer price to the brick and mortar store;
receiving an acceptance of the offer price from the brick and mortar store;
transmitting the acceptance of the offer price to the remote terminal;
receiving data confirming that the product was purchased by the consumer at the stated price at the brick and mortar store; and
transferring to the consumer a credit equal to the difference between the stated price and the offer price.

32. The method of claim 31, wherein the step of receiving from a remote terminal an offer from a consumer further comprises:
receiving from a remote terminal an offer from a consumer to buy the product at an offer price less than the stated price, and a value indicating a time period during which the offer price is valid.

33. The method of claim 32, wherein the step of transmitting the offer price further comprises:
transmitting the offer price to the brick and mortar store before the time period has expired.

34. The method of claim 33, wherein the step of transmitting the acceptance of the offer price further comprises:
transmitting the acceptance of the offer price to the remote terminal before the time period has expired.

35. The method of claim 34, wherein the step of receiving data further comprises:
receiving, from a second remote terminal at the brick and mortar store, data confirming that the product was purchased by the consumer at the stated price at the brick and mortar store, wherein the data pertains to a point of sale transaction corresponding to purchase of the product by the consumer.

36. The method of claim 35, wherein the step of receiving data further comprises:
receiving, from the remote terminal, data from the consumer confirming that the product was purchased by the consumer at the stated price at the brick and mortar store, wherein the data pertains to the point of sale transaction corresponding to purchase of the product by the consumer.

37. The method of claim 31, wherein the step of receiving data further comprises:
receiving data pertaining to a point of sale transaction corresponding to purchase of the product by the consumer at the stated price at the brick and mortar store; and
processing the data to determine its authenticity.

38. The method of claim 35, wherein the step of transferring to the consumer further comprises:
transmitting to the brick and mortar store an electronic request for a credit equal to the difference between the stated price and the offer price;
receiving from the brick and mortar store an electronic transfer of credit equal to the difference between the stated price and the offer price; and
initiating an electronic transfer of credit to an account of the consumer of an amount of credit equal to the difference between the stated price and the offer price.

39. The method of claim 35, wherein the step of transferring to the consumer further comprises:
transmitting to the brick and mortar store an electronic request for an amount of money equal to the difference between the stated price and the offer price;
receiving from the brick and mortar store an electronic transfer of money equal to the requested amount; and
initiating an electronic transfer of money to an account of the consumer of the requested amount.

40. The method of claim 35, wherein the step of transferring to the consumer further comprises:
initiating an electronic transfer of money to an account of the consumer of an amount of money equal to a difference between the stated price and the offer price.
